(19) United States
(12) Patent Application Publication
(10) Pub. No.: US 2014/0205908 A1
(43) Pub. Date: Jul. 24, 2014

(54) ENHANCED-SAFETY GALVANIC ELEMENT

(71) Applicants: Samsung SDI Co., Ltd., Yongin-si (KR); Robert Bosch GmbH, Stuttgart (DE)

(72) Inventors: Thomas Wöhrle, Munchen (DE); Markus Kohlberger, Stuttgart (DE)

(73) Assignees: Samsung SDI Co., Ltd., Yongin-si (KR); Robert Bosch GmbH, Stuttgart (DE)

(21) Appl. No.: 14/159,642

(22) Filed: Jan. 21, 2014

(30) Foreign Application Priority Data
Jan. 21, 2013 (DE) 10 2013 200 848.1

(51) Int. Cl. H01M 2/16; B29C 44/12

(52) U.S. Cl. CPC H01M 2/162; B29C 44/1209
USPC 429/246; 264/46.4; 264/424; 156/60

(57) ABSTRACT

A separator for a galvanic element, more particularly a lithium ion cell, includes at least one positive electrode and at least one negative electrode that are configured to be separated by a separator. The separator includes a substrate composed of at least one high-temperature-resistant, fiber-forming polymer that has a melting point above 200° C. The substrate also includes at least one further polymer that has a lower melting point than the high-temperature-resistant polymer of the substrate and that connects the fibers of the high-temperature-resistant polymer.

This application claims priority under 35 U.S.C. §119 to patent application no. DE 10 2013 200 848.1 filed on Jan. 21, 2013 in Germany, the disclosure of which is incorporated herein by reference in its entirety.

### BACKGROUND

In battery engineering, lithium ion technologies are deployed in a broad utility field. Lithium ion cells, which are also referred to as lithium ion polymer cells or lithium polymer cells or as corresponding modules, packs or batteries, accumulators, or systems, are galvanic elements which have at least one positive electrode and at least one negative electrode featuring an intercalation structure, into which lithium ions can be reversibly intercalated or deintercalated, i.e., inserted and removed, respectively. The intercalation and deintercalation processes require the presence of a lithium ion conductive salt. In lithium ion cells in the consumer sector (cellphone, MP3 player, etc.) but also in the automobile sector (hybrid electric vehicle (HEV), plug-in hybrid electric vehicle (PHEV), electric vehicle (EV), micro-hybrid), lithium hexafluorophosphate (LiPF₆) is used almost exclusively as lithium ion conductive salt. A separator separates the positive and the negative electrodes from one another, in particular in all operational states.

Lithium ion cells are notable for a very high specific energy density, or energy density, for an extremely low level of self-discharge, and for virtually no memory effect. However, lithium ion cells consistently contain flammable electrolytes and often other flammable cell materials, such as carbon black or aluminum foil. In the event of over charging or damage to a lithium ion cell, the cell may be opened and there may be emission of cell constituents or decomposition products, or fires or explosions. Accordingly, lithium ion cells ought to present internal safety mechanisms (intrinsic safety) and intrinsically safe materials, causing interruption to the current circuit and/or to lithium ion transport in the battery where appropriate. In the context of the intrinsic safety, a particular significance is accorded to the separator.

Within lithium ion technology, porous polyolefin separators are known, based on polyethylene (PE) or polypropylene (PP) or a corresponding composite. Above a certain temperature, particularly in the case of polyethylene (PE), there is rapid melting, meaning that the pores in the separator become blocked and the current circuit is irreversibly interrupted. Polyolefin-based separators, specifically, possess the adverse property under thermal stress of undergoing all-round contraction (shrinking), and within the cell there may be an extensive internal short circuit. The component having a higher melting temperature or softening temperature initially ensures a certain thermal and mechanical stability, although the stability can be maintained only to a limited extent.

DE 10 2009 035 759 A1 discloses a separator of a galvanic element which comprises at least partly a polymer whose melting or softening temperature is above 200° C. and which is distinguished by a low level of shrinking. High-temperature-resistant thermoplastic polymers of this kind, examples being polyetherketones (PEK) and polyetheretherketones (PEEK), display an increased thermal stability, although a reliable, integrated, heat-sensitive protection mechanism in the form of a shutdown mechanism is not ensured reliably and/or at any time.

DE 10 2009028 145 A1, moreover, discloses a ceramic membrane which takes the form of a flexible substrate, provided with numerous openings, having a porous inorganic coating on or in the substrate. The substrate is based on woven or nonwoven, electrically nonconductive fibers of polyaramid, and optionally comprises a further polymer which has a melting point lower than that of the polyaramid fibers, or the polyaramid fibers are connected to one another with a polymeric binder. Here as well, a shutdown mechanism is not ensured. Furthermore, the fraction of ceramic particles, which is high in some cases, leads to a higher cell weight for a given nominal capacity.

### SUMMARY

Proposed in accordance with the disclosure is a separator for a galvanic element, more particularly for a lithium ion cell, which comprises at least one lithium ion intercalating electrode and at least one lithium deintercalating electrode, and also a method for producing a separator and a galvanic element, with a separator of this kind separating the electrodes. The proposed separator, also identified as a composite separator, is a membrane comprising a substrate composed of a high-temperature-resistant, fiber-forming polymer whose melting point is above 200° C., and at least one further polymer, more particularly a polyolefin, which has a lower melting point than the high-temperature-resistant polymer. In particular the at least one polyolefin-based component connects the fibers of the high-temperature-resistant polymer to form a composite.

Membranes are generally thin, porous systems with high porosity for certain substances, in conjunction with good mechanical strength and long-term stability toward the substances they are in contact with. Furthermore, the requirements are for resistance to oxidation, low weight tolerance and thickness tolerance, low ion passage resistance, high electron passage resistance, retention capacity for particulate solids detached from the electrodes, spontaneous and long-term wettability by the electrolyte, and a high storage capacity for the electrolyte liquid, combined with mechanical, thermal, and electrochemical stability. The membrane ought overall to possess a porosity which is sufficient to be filled up with the electrolyte used in a galvanic element. Further arising are properties which are determined by the materials used and by their geometry/morphology. These properties relate to a low thickness for low ion passage resistance, a high porosity in tandem with homogeneous pore distribution, and mechanical strength. The pore size ought to be selected, and is preferably adjustable, in such a way that on the one hand it is small enough that no dendrites grow through in batteries, and on the other hand is large enough to be sufficiently filled with electrolyte. Furthermore, a labyrinthine porosity is preferable, since the deposition of lithium dendrites is prevented, in contrast to an open porosity. Other factors to be considered, however, include the expansion of the material when a voltage is applied, the mechanical stability, and the costs of producing an appropriate membrane.

High-temperature-resistant polymers are those whose melting points lie above 200° C. The melting point is the temperature at which a substance melts, i.e., passes from the solid into the liquid aggregate state. For polymers, this temperature is not always readily determinable, since there may possibly be decomposition phenomena beforehand. Consequently it is possible instead, as a characteristic value, to state the softening temperature, also referred to as glass transition temperature, this being the temperature at which a polymer exhibits the greatest change in capacity for deformation. Furthermore, it may be advisable to specify temperature ranges, with the melting and/or softening temperature indicating the lower limit of the range.

The membrane proposed as separator of the disclosure is based on a substrate composed of high-temperature-resistant, fiber-forming polymers, selected from the group encompassing polyesters, e.g., polyethylene terephthalate (PET), polyethylene naphthalate (PEN), polyimide (PI), polytetrafluoroethylene (PTFE), polyvinylidene fluoride (PVdF), polyvinylidene fluoride-hexafluoropropylene copolymer (PVdF-HFP), polyurethane (PU), polyamide (PA), polysulfones, polyethersulfones, aramids, or copolymers of the aforementioned polymers.

The high-temperature-resistant, fiber-forming polymer which represents a basis of the separator of the disclosure is present in the form of unwoven fibers which are not electrically conductive.

The diameters of the fibers in the high-temperature-resistant polymers here may be in a range from 0.9 to 10 μm, preferably 2 to 5 μm, which is in turn important for the weight of the membrane. The membrane may accordingly have a thickness of 4 to 50 μm, preferably of 15 to 30 μm, and more preferably of 10 to 20 μm. During the manufacturing process, the fibers of the substrate are connected to one another, for example, by means of methods known from the prior art, including for instance binding fibers, hot-melt adhesives, chemical binders, or partial melting of the fibers.

The substrate, which may take the form of a nonwoven, knitted, or woven fabric, preferably has a thickness of 10 μm to 50 μm, preferably of 15 μm to 30 μm. When the membrane of the disclosure is used as separator in a galvanic element, the thickness of the substrate is important for the flexibility but also for the sheet resistance of the separator impregnated with an electrolyte Thinner separators in principle permit an increased packing density in a battery stack, allowing a greater energy quantity or nominal capacity to be stored within a given volume.

The substrate preferably takes the form of a random-laid fiber scrim, also termed a nonwoven. Substrates of this kind exhibit very low contraction on heating, and very good thermal and mechanical stability. In the case of a fiber braid, in contrast, the nature of the braiding may indeed be used to set a certain mechanical strength and a corresponding elasticity, but a membrane of that kind is directionally assigned.

The separator of the disclosure, as well as having the substrate, also termed base substrate, composed of a high-temperature-resistant, fiber-forming polymer, features a further component, which is a polyolefin-based polymer. Suitable polyolefins are selected from the group encompassing polyethylene, polypropylene, and polyethylene-polypropylene copolymers. Polyolefin-based polymers of these kinds are used in lithium ion technology, since these polymers, in relation to the requirements referred to above, have proven suitable as a separator for a galvanic element and are chemically stable in the cell. The polyolefin-based polymers are, in particular, intercalated in the free spaces between the fibers of the high-temperature-resistant polymer.

In one embodiment, the separator of the disclosure has a porosity which is set by means of a method for producing the separator, this method being described in more detail hereinafter. The porosity in this context is defined as the volume of the composite that is not filled by material, and is situated in particular in a range from 20 to 80.

The method for producing the separator of the disclosure starts from a base substrate composed of a high-temperature-resistant polymer in the form of a porous membrane which is present as a random-laid fiber braid. Subsequently, in the free spaces between the fibers of the base substrate, at least one polyolefin-based polymer is incorporated, and so the high-temperature-resistant fibers are also connected by the polyolefin-based polymer. The at least one polyolefin-based polymer is notable in particular for a lower melting and/or softening point than the polymer of the base substrate. In some cases, polymers do not exhibit a precise temperature value at which they melt. In a further step in the method, a defined porosity is set.

In one exemplary embodiment, the porosity is induced by means of a component which besides the polyolefin-based polymer is introduced as filler into the base substrate. Fillers of this kind may be, for example, a mineral oil, which is removed again by chemical or thermal extraction after the composite has been produced, generating pores of desired size and distribution.

Alternatively, a desired porosity may be generated by beam bombardment of the manufactured composite, as for example by bombardment with electron beams, or else by piercing. Also suitable for setting a defined porosity in the separator of the composite, however, are the stretching or drawing methods known in the prior art.

The incorporation of the at least one polyolefin-based polymer into the free spaces in the substrate may take place by means of hot lamination or under mechanical pressure. For example, the at least one polyolefin-based polymer, in the form of fine particles, may be plated into the substrate fabric by mechanical pressure or incorporated by hot lamination.

In a further embodiment, the at least one polyolefin-based polymer component is incorporated into the structure of the substrate by means of extrusion.

The separators of the disclosure are used preferably in galvanic elements which comprise at least one lithium ion-intercalating electrode and one lithium ion-deintercalating electrode. Additionally provided by the present application is a galvanic element, more particular a lithium ion cell, having a separator of the disclosure. The galvanic element has at least one positive electrode and one negative electrode, with the sequence present being negative electrode/separator/positive electrode.

A feature of the solution proposed in accordance with the disclosure is that the separator proposed in accordance with the disclosure and the galvanic element proposed in accordance with the disclosure provide a substantially higher safety level. Accordingly, under the conditions of an abuse test, for example, more particularly on thermal stress in the fully charged state of the cell, resulting safety properties are enhanced.

The substrate used in the separator of the disclosure, composed of a high-temperature-resistant, fiber-forming polymer, is notable for qualities including a high tensile strength and puncture resistance. Furthermore, polymers of this kind exhibit significantly reduced peripheral contraction, and so a separator proposed in accordance with the disclosure is thermally and mechanically stable and exhibits no change in geometry, of whatever kind.

The separator proposed in accordance with the disclosure may be produced in an extremely cost-effective way by modification of an unwoven membrane made from a high-melting polymer, and, in particular, the porosity to be generated can be adapted to the individual conditions. The combination of a chemically, electrochemically, and mechanically stable, high-melting polymer-based separator having a labyrinth porosity, with polyolefin-based polymer incorporated in-between the fibers, and with a porosity which can be set, affords a very high degree of intrinsic safety, which has beneficial consequences for the safety performance of the cell.

### BRIEF DESCRIPTION OF THE DRAWINGS

Further advantages and embodiments of the subject matter of the disclosure are illustrated by means of the drawings, and elucidated in more detail in the description below.

In the drawings

FIG. 1 shows the migrational direction of lithium⁺ ions during charging, from the positive electrode to the negative electrode,

FIG. 2 shows the migrational direction of lithium⁺ ions during discharging, from the negative electrode to the positive electrode,

FIG. 3 shows a schematic cross section through one embodiment of a separator of the disclosure,

FIG. 4 shows a schematic plan view of one embodiment of a separator of the disclosure.

### DETAILED DESCRIPTION

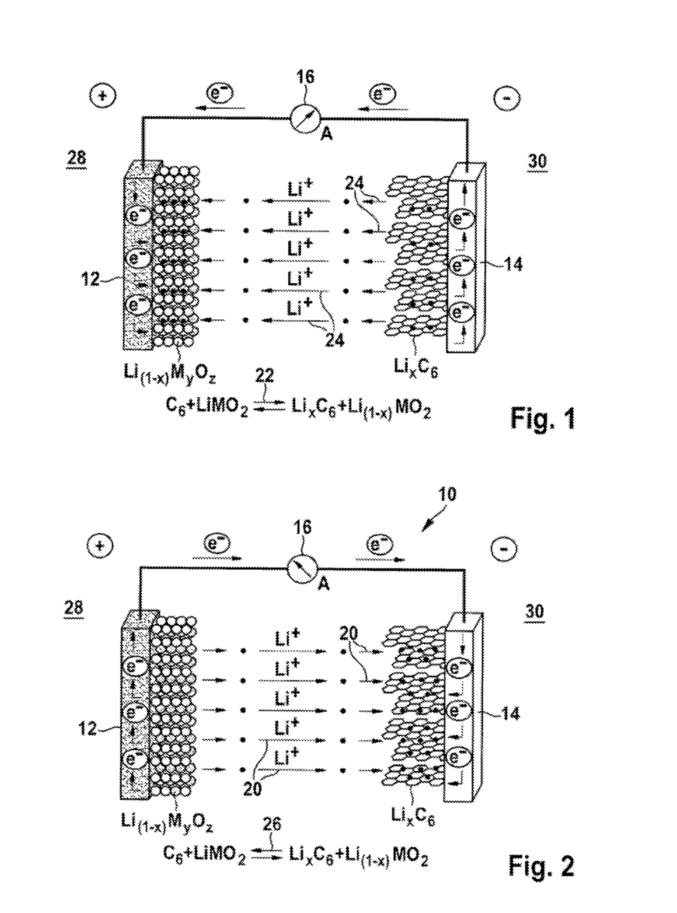

Apparent from the depiction according to FIG. 1 is the migrational direction of the Li⁺ ions during the charging 22 of a galvanic element.

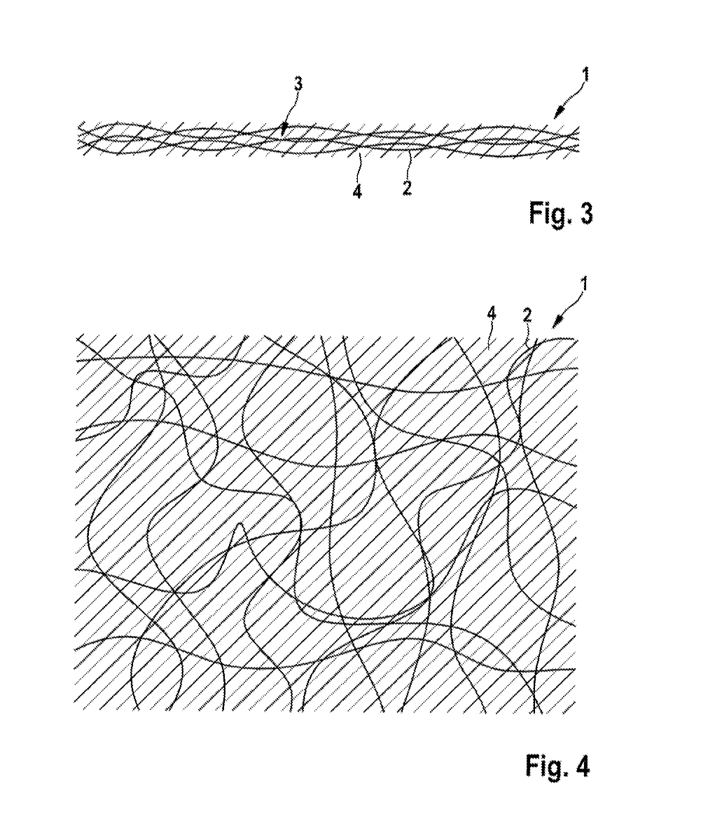

A galvanic element 10, whose components are indicated only schematically in FIG. 1, comprises a positive electrode 12 (anode) and a negative electrode 14 (cathode). A current flowing between the two electrodes 12 and 14 can be measured by means of an ammeter 16. Located in the space between positive and negative electrodes 12 and 14 is a lithium ion-conducting electrolyte. Generally speaking, the electrolyte is a liquid electrolyte, as for example a 1-molar solution of lithium hexafluorophosphate LiPF₆ in a mixture of organic solvents. The organic solvents may be, for example, ethylene carbonate (EC), propylene carbonate (PC), ethyl methyl carbonate (EMC), diethyl carbonate (DEC), or symmetrical or asymmetrical ethers. This liquid electrolyte ensures the wetting of a separator, which is depicted in more detail in connection with FIG. 3.

FIG. 1 indicates a migrational direction of the Li⁺ ions during charging 22 by means of reference symbol 20.

Charging 22 is evident from the following reaction equation:

C₆+LiMO₂→LiC₆+Li₍ᵢ₋ₓ₎MO₂

M=transition metal oxide, as for example cobalt (Co), manganese (Mn) or nickel (Ni).

Furthermore, reference symbol 28 indicates the positive side of the galvanic element 10, and reference symbol 30 the negative side.

The depiction according to FIG. 2 shows discharging 26 of the galvanic element 10, with the Li⁺ ions migrating, in opposition to the migrational direction 20 depicted in FIG. 1, from the negative electrode 14 to the positive electrode 12, this migration being identified by reference symbol 24.

The construction of the galvanic element 10 according to the depiction in FIG. 2 is analogous to the construction of the galvanic element 10 according to the depiction in FIG. 1, with FIG. 2 showing discharging 26. Discharging 26 is likewise based on the reaction equation above, which, however, proceeds in the opposite direction.

The depiction according to FIGS. 1 and 2 serves for depicting the reversible insertion and removal, i.e., the intercalation and deintercalation, of the Li⁺ ions.

FIG. 3 shows a cross section through a separator 1 of the disclosure, with a first component 2 in the form of a random-woven fiber fabric 3.

Component 2 comprises a high-melting polymer, as for example polyester, polyimide, aramid or polyethersulfone. In the exemplary embodiment depicted in FIG. 3, the random-woven fiber fabric 3 made from high-melting polymer is present in a thickness range from 4 to 50 μm, preferably in a range from 15 to 30 μm. The random-woven fiber fabric 3 therefore combines the qualities of a low thickness with a high mechanical stability, and so a separator 1 of this kind as well can also be subjected to a bending and shearing stress.

Located between the individual fibers of the random-woven fiber fabric 3 is a second component 4, which is a polyolefin-based polymer. As can be seen from FIG. 3, the fibers of the random-woven fiber fabric 3 are connected to one another by the melted component 4, thereby ensuring the cohesion of the flexible separator in an innovative way. The composite separators 1 of the disclosure, realized in terms of their thickness relative to conventional separators, can be used, for example, in high-performance batteries, examples being lithium ion batteries. A battery constructed in this way has largely greater intrinsic safety within a wide temperature range, from 50° C. to 300° C., in corresponding abuse tests.

FIG. 4 shows a plan view of a separator 1 of the disclosure, and again the component 2 can be seen, depicted as a random-woven fiber fabric 3 with individual fibers, and the component 4, a polyolefin-based polymer, can be seen, this component 4 being incorporated between said fibers.

The present disclosure is described in more detail by the examples which follow.

### Example 1

### Li Ion Cell with a Reference Separator

A reference separator comprises a porous polyethylene membrane with a thickness of approximately 20 μm. The Li ion cell constructed according to Example 1 comprises a positive active composition, consisting of lithium nickel cobalt manganese oxide (LiNi_{0.33}CO_{0.33}Mn_{0.33}), and a negative active composition, consisting of natural graphite.

Ten specimen cells were constructed, and the nominal capacity achieved was 4.2 Ah. The 100% SOC (state of charge) of the cell is 4.15 V.

### Example 2

### Li Ion Cell with an Inventive Separator in Accordance with an Exemplary Embodiment

An inventive separator comprises a porous composite membrane with a thickness of approximately 20 μm, composed of polyester as component 2 and polyethylene as component 4. The Li ion cell constructed according to Example 2 comprises a positive active composition of lithium nickel cobalt manganese oxide (LiNi_{0.33}Co_{0.33}Mn_{0.33}), and a negative active composition of natural graphite.

Ten specimen cells were constructed, and the nominal capacity achieved was 4.2 Ah. The 100% SOC (state of charge) of the cell is 4.15 V.

The Li ion cells, comprising a reference separator and an inventive separator, were subjected to a safety test, the UL 1642 oven test (Underwriters Laboratories; 1642: Standard Safety Test for Lithium Ion Batteries). The parameters observed in this test were as follows: temperature of about 150° C. for 10 minutes with batches of 10 cells with a cell voltage of 4.15 V (100% SOC).

The result of the UL 1642 oven test shows that five of the 10 reference cells caught fire and burnt, whereas 10 out of 10 inventive cells exhibited no adverse effect. It is therefore found that with a composite separator constructed in accordance with the disclosure, a protective effect can be achieved under—for example—thermal stress.

What is claimed is:

1. A separator for a galvanic element including at least one positive electrode and one negative electrode to be separated by the separator, comprising:
a substrate including (i) at least one high-temperature-resistant, fiber-forming polymer having a melting point above 200° C. and (ii) at least one further polymer having a lower melting point than the high-temperature-resistant polymer of the substrate and being configured to connect the fibers of the high-temperature-resistant polymer.

2. The separator according to claim 1, wherein the at least one high-temperature-resistant, fiber-forming polymer is selected from the group encompassing substantially polyester, polyimide, aramid, and polyethersulfone.

3. The separator according to claim 1, wherein the at least further polymer is selected from the group of the polyolefins, containing substantially polyethylene, polypropylene, and polyethylene-polypropylene co-polymers.

4. The separator according to claim 1, wherein the substrate composed of high-temperature-resistant, fiber-forming polymer is configured in the form of random fiber fabric.

5. The separator according to claim 1, wherein the separator has a porosity of 20 to 80.

6. The separator according to claim 1, wherein the separator is configured in a thickness range between 4 μm and 50 μm.

7. A method for producing a separator, comprising:
introducing at least one further polymer to a substrate of a high-temperature-resistant, fiber-forming polymer, the high-temperature-resistant, fiber-forming polymer having a melting point above 200° C., the further polymer having a melting point lower than the melting point of the high-temperature-resistant, fiber-forming polymer; and
generating a porosity in the separator.

8. The method according to claim 7, wherein the introduction of the further polymer to the substrate takes place by hot lamination.

9. The method according to claim 7, wherein the introduction of the further polymer to the substrate takes place by extrusion.

10. The method according to claim 7, wherein the generation of the porosity in the separator takes place by beam bombardment.

11. The method according to claim 7, wherein the generation of the porosity in the separator takes place by a stretching operation.

12. The method according to claim 7, wherein the generation of the porosity in the separator comprises the removal of a filler incorporated into the separator.

13. A galvanic element, comprising:
at least one lithium ion-intercalating electrode;
at least one lithium ion-deintercalating electrode; and
at least one separator configured to separate the at least one lithium ion-intercalating electrode and the at least one lithium ion-deintercalating electrode, the separator including:
a substrate including (i) at least one high-temperature-resistant, fiber-forming polymer having a melting point above 200° C. and (ii) at least one further polymer having a lower melting point than the high-temperature-resistant polymer of the substrate and being configured to connect the fibers of the high-temperature-resistant polymer.

14. The galvanic element according to claim 13, wherein a motor vehicle includes the galvanic element.

15. The separator according to claim 1, wherein the separator is configured for a lithium ion cell.

16. The separator according to claim 6, wherein the thickness range is between 15 μm and 30 μm.
